(19) United States
(12) Patent Application Publication
(10) Pub. No.: US 2026/0124481 A1
(43) Pub. Date: May 7, 2026

(54) A PRESSURE GAUGE FOR A PORTABLE PRESSURIZED FIRE EXTINGUISHER

(71) Applicant: PROGRESSIVE SAFETY SWEDEN AB, Jonkoping (SE)

(72) Inventor: Ahmed MIREE, Goteborg (SE)

(21) Appl. No.: 19/114,442

(22) PCT Filed: Sep. 27, 2023
(86) PCT No.: PCT/SE2023/050950

§ 371 Date: Mar. 22, 2025

(30) Foreign Application Priority Data
Sep. 29, 2022 (SE) 2251120-8

(51) Int. Cl. A62C 37/50; A62C 13/76; G01L 19/08

(52) U.S. Cl. CPC A62C 37/50; A62C 13/76; G01L 19/083

(57) ABSTRACT

A pressure gauge (10) for a portable pressurized fire extinguisher comprising a pressure sensor (30), a LoRa radio interface (20) and a power source (70); the pressure sensor (30) is configured to sense an inner gas pressure of the portable pressurized fire extinguisher; and the LoRa radio interface (20) is powered by the power source (70) and configured to transmit pressure data from the pressure sensor (30) to a management server; wherein the pressure gauge (10) further comprises a near-field communication NFC interface (40), which is configured to send and receive pressure data to and from the pressure sensor (30).

### TECHNICAL FIELD

The present invention relates generally to a pressure gauge for a portable pressurized fire extinguisher comprising a pressure sensor, a LoRa radio interface and a power source, a system and uses thereof.

### BACKGROUND ART

A fire extinguisher is an active fire protection device used to extinguish or control small fires, often in emergency situations. Typically, a fire extinguisher consists of a hand-held cylindrical pressure vessel comprising a fire extinguishing agent that can be discharged to control a fire.

A fire extinguisher in the commercial/professional market undergoes inspections regularly. The service is performed by a trained technician from a fire extinguisher company. In connection with the service, the technician makes sure to check the pressure level and that the extinguisher is undamaged and in its place. Since this service is performed at regular intervals, sometimes once a year, it is not entirely certain that the fire extinguisher is functional/accessible when a fire occurs.

Additionally, lack of maintenance can lead to a fire extinguisher that does not work when an emergency situation arises. In the worst cases, the lack of maintenance can lead to the explosion of the fire extinguisher, which continues to cause deaths every year.

The solutions as known in prior art require the inspection of the fire extinguishers in place, which requires complex maintenance schedules and a high number of employees. Moreover, even solutions with some degree of external monitoring also require inspection for regularly exchanging the energy source of those solutions, which increases costs and management complexity.

It would thereby be beneficial to provide a solution where fewer periodical inspections are required and that can continuously monitor the fire extinguisher for longer periods of time. Other applications would also benefit from said solution, such as gas cylinders for use in hospitals and/or industry.

### SUMMARY OF INVENTION

An object of the disclosure is to at least partially overcome the above problems, such as to provide a pressure gauge which can be monitored all the time. Another object of the disclosure is to provide a pressure gauge which requires low energy for functioning and that sends an alarm when a threshold is reached.

The objects are solved by providing a pressure gauge for a portable pressurized fire extinguisher comprising a pressure sensor, a LoRa radio interface and a power source, the pressure sensor being configured to sense an inner gas pressure of the portable pressurized fire extinguisher, and the LoRa radio interface being powered by the power source and configured to transmit pressure data from the pressure sensor to a management server, wherein the pressure gauge further comprises a near-field communication (NFC) interface, which is configured to send and receive pressure data to and from the pressure sensor.

One exemplary effect of the disclosed pressure gauge is the provision of a low energy consumption device which can monitor the inner gas pressure of the portable pressurized fire extinguisher. Said portable pressurized fire extinguisher consumes less energy due to its low energy consumption components, which provides a device that requires less regular maintenance by trained personnel and that allows monitoring of the portable pressurized fire extinguisher for longer time periods. Additionally, said device is advantageously configured to send and receive pressure data to a management server, thereby allowing continuously monitoring of pressure data. Said continuously monitoring advantageously provides a portable pressurized fire extinguisher which is ready for use and not for instance with a pressure value outside the requirements.

The NFC interface may also be configured to send and receive other relevant data, for instance temperature data from a temperature sensor or movement data from a motion sensor, as described elsewhere herein.

The pressure gauge according to the disclosure may be used for any application where a pressure gauge is be needed, such as for therapeutic gases stored in cylinders at hospitals, gases stored in cylinders for use in industry and more.

According to one exemplary embodiment, said pressure gauge is configured to have an upper pressure threshold and/or a lower pressure threshold for the inner gas pressure of the portable pressurized fire extinguisher. One effect thereof is that said upper and lower pressure thresholds advantageously provide a pressure range considered a working pressure for normal operation, a range where the pressure is considered too high and/or a range where the pressure is considered too low.

According to one exemplary embodiment, the LoRa radio interface is configured to only transmit pressure data from the pressure sensor to the management server when the upper and/or lower threshold is/are reached, thus significantly reducing the energy consumption of the pressure gauge. The pressure gauge may have only an upper pressure threshold and/or only a lower pressure threshold.

According to another exemplary embodiment, the upper pressure threshold and/or the lower pressure threshold can be updated by an external device through the pressure data communicated by the NFC interface. One effect thereof is the provision of a pressure gauge wherein the pressure thresholds can be changed according to the type/size of fire extinguisher and/or regulations in different regions or countries. Moreover, the pressure thresholds can be updated based on the requirements for a specific location, such as for a commercial building, a house, a factory and so on. Another effect thereof is that the use of NFC interface does not consume energy of the power source and thus does increase the life span of the pressure gauge.

According to another exemplary embodiment, said pressure gauge is configured to send an alarm to the management server when the upper pressure threshold and/or the lower pressure threshold is/are exceeded. One effect thereof is that an alarm is immediately triggered when the pressure of a pressurized fire extinguisher is above and/or below an acceptable range, thereby notifying the responsible person or company of the need of immediate service. Additionally, the fact that the alarm is only sent when a threshold is exceeded allows the staff monitoring data received by the management server to monitor a large number of pressurized fire extinguishers at the same time and to act on those cases where said thresholds are exceeded.

Pressure data may be collected at least every 0.5 minute, such as every 1, every 2, every 5, every 10, every 25 or every 30 minutes or more. Additionally, pressure data collected and stored in the memory of the system core may be sent to the management server by the LoRa radio interface less often in order to reduce energy consumption, such as every hour, every 6, every 12, every 18 or every 24 hours or more. On the other hand, an alarm and/or pressure data may be immediately sent to the server when a lower and/or upper pressure threshold is/are exceeded.

According to one exemplary embodiment, the pressure gauge further comprises a temperature sensor, wherein the pressure gauge is configured to have an upper temperature threshold and/or a lower temperature threshold for the surroundings of the portable pressurized fire extinguisher. The surroundings may be the room where the pressure gauge is located. One exemplary effect thereof is that said upper and lower temperature thresholds advantageously provide a temperature range considered a working temperature for normal operation, a range where the room temperature is considered too high and a range where the temperature is considered too low. When the upper temperature threshold is exceeded, it may for instance indicate the presence of a fire. When the lower temperature threshold is exceeded, it may for instance indicate that the fire extinguisher may not function properly, the hoses and valves maybe cracked, the fire extinguisher has been moved to a cold location and/or that the content of the fire extinguisher is frozen. In some embodiments, temperature data may only be sent to the management server when the upper and/or lower threshold is/are reached, thus significantly reducing the energy consumption of the pressure gauge. The temperature sensor of the pressure gauge may have only an upper temperature threshold or only a lower temperature threshold.

According to another exemplary embodiment, said pressure gauge is configured to send an alarm to the management server when the upper temperature threshold and/or the lower temperature threshold is/are exceeded. One effect thereof is that an alarm is immediately triggered when the temperature of the surroundings of the pressurized fire extinguisher is above or below an acceptable range, thereby notifying the responsible person or company of the need of immediate service. Additionally, the fact that the alarm is only sent when a threshold is exceeded allows the staff monitoring data received by the management server to monitor a large number of pressurized fire extinguishers at the same time and to act on those cases where said thresholds are exceeded. In some embodiments, when a plurality of pressure gauges in the same building, floor or room sends an alarm due to the upper threshold being exceeded, said alarm may indicate a fire in the building, floor or room and/or the approximate location of said fire.

According to one exemplary embodiment, the power source is an electric battery. One exemplary effect thereof is that the pressure gauge does not need to be connected to an outlet or an external power source., thereby increasing the mobility of the pressurized fire extinguisher since it can be freely moved in a room. Furthermore, said electric battery may be sufficient for powering the pressure gauge for longer periods of time due to the low energy consumption of the pressure gauge. In some embodiments, said periods of time may be up to 1 year or more, such as 5 years or more or 10 years or more.

According to another exemplary embodiment, the pressure gauge further comprises a motion sensor, such as an accelerometer, configured to detect a displacement of the portable pressurized fire extinguisher. One exemplary effect thereof is that an unduly displacement of the fire extinguisher may be detected and the data may be sent to the management server for further action or for investigation. Due to strict regulations in most countries, the fire extinguishers must be placed in specific places in a room/building and cannot be moved until it is needed to suppress a fire.

According to one exemplary embodiment, said pressure gauge is configured to send an alarm to the management server when a motion threshold is exceeded. One effect thereof is that an alarm is immediately triggered when the motion threshold of the pressurized fire extinguisher is exceeded, thereby notifying the responsible person or company of the need of immediate service. Additionally, the fact that the alarm is only sent when a threshold is exceeded allows the staff monitoring data received by the management server to monitor a large number of pressurized fire extinguishers at the same time and to act on those cases where said threshold(s) is/are exceeded.

According to another exemplary embodiment, the pressure gauge further comprises a light indicator, such as a LED light indicator. One exemplary effect thereof is that the light indication shows on site the current status of the portable pressurized fire extinguisher. Said light indication may be always active or may be only active when activated by a user or maybe only active when a threshold is exceeded. In some embodiments, the light indicator may be activatable by tapping or touching said light indication by a user. A LED light indication may be preferred due to its low energy consumption, which increases the life span of the pressure gauge. The light indication may blink, flash or turn on for a period of time, when activated.

According to another exemplary embodiment, said light indication is configured to display a status of the portable pressurized fire extinguisher, said status being defined as normal, low pressure or high pressure. One exemplary effect thereof is that the status display of the portable pressurized fire extinguisher immediately shows to a user whether the pressurized fire extinguisher is functional or not. The status being defined as working pressure for normal operation indicates that the fire extinguisher may be used, while the status being defined as low pressure or high pressure may indicate that said fire extinguisher needs to be inspected, repaired or changed. The different statuses of the portable pressurized fire extinguisher may for instance be displayed as different blinking patters or by different colors.

According to one exemplary embodiment, said light indicator is configured to display a light signal when the upper pressure threshold and/or the lower pressure threshold is/are exceeded. One effect thereof is that it becomes immediately evident to a user that a threshold is/are exceeded, thereby allowing the inspection service to be contacted by the user and/or indicating the user that said fire extinguisher is not functioning properly and that said user should use another fire extinguisher, if so required. In some embodiments, said light indicator may blink, flash or turn on for a period of time when a threshold is exceeded. Said light indicator may have different colors depending on which threshold(s) is/are exceeded.

Another aspect of the disclosure is related to a portable pressurized fire extinguisher comprising a pressure gauge as defined above. Said portable pressurized fire extinguisher is known by the skilled person, but may comprise for instance a dry chemical, foam based or water-based fire extinguisher.

Another aspect of the disclosure is related to a use of the pressure gauge, as defined elsewhere herein, for monitoring a portable pressurized fire extinguisher.

Another aspect of the disclosure relates to a system comprising a plurality of pressure gauges as defined herein and plurality of portable pressurized fire extinguishers, wherein each one of the plurality of pressure gauges is connected to each one of the plurality of portable pressurized fire extinguisher. Advantageously, said system allows protecting an area and objects therein from fire. Furthermore, the system as a whole consumes less energy due to its low energy consumption components, which provides a system that requires less regular maintenance by trained personnel and that allows monitoring of the area and objects therein for longer time periods.

### BRIEF DESCRIPTION OF DRAWINGS

The invention is now described, by way of example, with reference to the accompanying drawings, in which:

FIG. 1 illustrates one exemplary schematic embodiment of a blocking diagram of a pressure gauge.

FIG. 2 illustrates a portable pressurized fire extinguisher comprising a pressure gauge, according to one exemplary embodiment.

FIG. 3 illustrates a pressure gauge device, according to one exemplary embodiment.

### DESCRIPTION OF EMBODIMENTS

In the following, a detailed description of the different embodiments of the invention is disclosed under reference to the accompanying drawings. All examples herein should be seen as part of the general description and are possible to combine in any way of general terms. Individual features of the various embodiments and aspects may be combined or exchanged unless such combination or exchange is clearly contradictory to the overall function of the pressure gauge for a portable pressurized fire extinguisher 1.

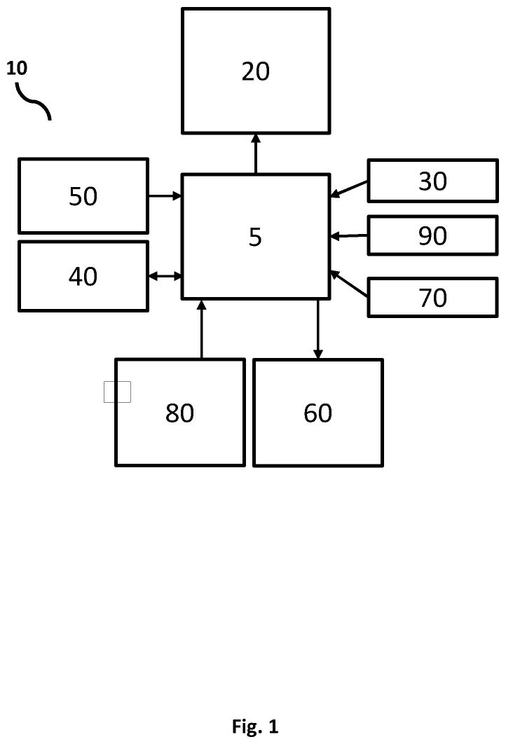

FIG. 1 illustrates a blocking diagram of a pressure gauge 10 for a portable pressurized fire extinguisher 1 comprising a pressure sensor 30, a LoRa radio interface 20, a system core 5 and a power source 70. The pressure sensor 30 is configured to sense an inner gas pressure of the portable pressurized fire extinguisher 1. The skilled person knows which pressure sensors are suitable for measuring the inner gas pressure of the portable pressurized fire extinguisher 1. The pressure sensor 30 may sense up to 30 bar pressure. Additionally, the system core 5 is known in the art and may comprise one or more processors, such as microprocessors, configured to execute instructions related to the pressure gauge 10 as described herein.

Furthermore, the pressure gauge 10 further comprises a LoRa radio interface 20 powered by the power source 70. The LoRa radio interface 20 is configured to transmit pressure data from the pressure sensor 30 to a management server. The pressure data may be actual pressure values or may be binary “normal”/“not normal” pressure data. The pressure data may be collected at least every 0.5 minute, such as every 1, every 2, every 5, every 10, every 25 or every 30 minutes or more. Further, the pressure data may be stored in the memory of the system core 5.

The pressure data may be transmitted to the management server in different time periods depending on the type of fire extinguisher, the place of installation or specific regulatory requirements to be met. Said time periods may be for instance every hour, every 6 h, every 12 h, every 18 h or every 24 hours or more. On the other hand, the alarm and/or pressure data is immediately sent to the server when a lower and/or upper pressure threshold is/are exceeded. Moreover, the LoRa radio interface 20 may be configured to transmit other data to the management server, such as temperature data and/or motion data.

The LoRa radio interface 20 may have a long range, such as about 700 meters. The skilled person knows the limits and ranges of radio frequency via LoRa protocol, as well as its advantages, such as to enable long-range transmission with low energy consumption. It is advantageous that the LoRa radio interface 20 only sends data, which further reduces energy consumption of the pressure gauge 10 device.

The LoRa radio interface 20 transmits data from the pressure sensor 30 to a management server, which may be a cloud server. Said management server receives and stores pressure data sent by LoRa radio interface 20 of the pressure gauge 10.

The power source 70 of the pressure gauge 10 is preferably an electric battery. Said electric battery is standard and the skilled person knowns which ones are suitable for the pressure gauge 10, for instance CR2450 or any similar electric batteries. The electric battery may need to be substituted every about 10 years or more.

The pressure gauge 10 further comprises a near-field communication (NFC) interface 40 configured to send and receive pressure data to and from the pressure sensor 30. Moreover, the NFC interface 40 may be configured to send and receive other data, including system parameters such as device type, serial number, credentials, thresholds, gas type and concentration, expiration date, gas container size and more. The skilled person is aware of different NFC standards suitable for said application and that that NFC standards cover different communications protocols and data exchange formats and that it is based on existing radio-frequency identification (RFID) standards, for instance ISO/IEC 14443 and FeliCa.

The pressure gauge 10 is configured to have an upper pressure threshold and/or a lower pressure threshold for the inner gas pressure of the portable pressurized fire extinguisher 1, which may be updated by the NFC interface 40. The upper and lower pressure thresholds may be updated according to the specifications of the fire extinguisher, including its size, extinguishing agent, etc. Moreover, the pressure data is collected and stored in the memory of the system core 5. Said pressure data collection is made at least every 0.5 minute, such as every 1, every 2, every 5, every 10, every 25 or every 30 minutes or more. The time interval of pressure data collection may depend on the type of fire extinguisher and may affect the battery life span of the pressure gauge 10.

The pressure gauge 10 is configured to send an alarm to the management server when the upper pressure threshold and/or the lower pressure threshold is/are exceeded. Said alarm is sent through the LoRa radio interface 20 immediately after a threshold is exceeded. If no threshold has been reached, pressure data may be sent to the management server after an amount of pressure data has been collected, such as every hour, every 6, every 12, every 18 or every 24 hours or more. Said time interval advantageously allows sending a plurality of pressure data to the management server at the same time, and thus saving energy of the pressure gauge 10. On the other hand, an alarm is immediately sent to the management server when a lower and/or upper pressure threshold is/are exceeded, regardless of which time interval for sending data is configured in the pressure gauge 10.

The pressure gauge 10 further comprises a temperature sensor 90 and is configured to have an upper temperature threshold and/or a lower temperature threshold for the surroundings of the portable pressurized fire extinguisher 1. Said upper and lower temperature thresholds may be updated by an external device through the temperature data communicated by the NFC interface 40. Moreover, the upper and lower temperature thresholds may be temperature values where the proper functioning of the pressure gauge 10 and/or the fire extinguisher is endangered. In some embodiments, the upper temperature threshold may indicate a high likelihood of a fire in the room where the pressure gauge 10 is located. The lower temperature threshold may be a temperature where the extinguishing agent is likely to be frozen or at a non-working state.

Furthermore, the pressure gauge 10 is configured to send an alarm to the management server when the upper temperature threshold and/or the lower temperature threshold is/are exceeded. Said alarm is sent through the LoRa radio interface 20 immediately after a threshold is exceeded. Furthermore, different alarms with different prioritizations (e.g., high or low priority) may be sent to the management server depending on whether it is an upper or a lower temperature threshold that is exceeded. For instance, an upper temperature threshold may be regarded as having a high priority, while a lower temperature threshold may be regarded as having a low priority.

The pressure gauge 10 further comprises a motion sensor 50, such as an accelerometer, configured to detect a displacement of the portable pressurized fire extinguisher 1. The motion sensor is configured to detect any displacement of the portable pressurized fire extinguisher 1, which allows monitoring an unallowed movement of the device. Due to regulatory requirements, fire extinguishers must be placed in specific places in a room/building and should not be moved in order to be accessible when needed.

Furthermore, the pressure gauge 10 is configured to send an alarm to the management server when a motion threshold is exceeded. Said alarm is sent through the LoRa radio interface 20 immediately after a motion threshold is exceeded. Moreover, said motion threshold may be updated by an external device through the motion data communicated by the NFC interface 40.

The pressure gauge 10 further comprises a light indicator 60, such as a LED light indicator 60. Said light indicator 60 is a quick and effective way to show the actual status of the portable pressurized fire extinguisher 1. The status of the portable pressurized fire extinguisher 1 may be a binary “ok/not ok” or may be defined as normal, low pressure or high pressure. The status of the portable pressurized fire extinguisher 1 may only be shown in case the pressure status is high and/or low. In some embodiments, in order to save more energy, said status of the portable pressurized fire extinguisher 1 is only shown after activation of said light indicator 60, for instance by a user touching or tapping the pressure gauge 10.

Furthermore, said light indicator 60 is configured to display a light signal when the upper pressure threshold and/or the lower pressure threshold is/are exceeded. Said light signal is displayed independently of the alarm being sent to the management server when said thresholds are exceeded and serves as an effective way of visually showing a user that a pressure threshold was exceeded.

The pressure gauge 10 further comprises an on/off switch 80, which advantageously provide a simple way to activate or deactivate the pressure gauge 10. When the on/off switch 80 is turned off, data from the pressure sensor 30, the temperature sensor 90 and the motion sensor 50 is not saved by the system core 5. Furthermore, no data sent to the management server by the LoRa interface 20. Said on/off switch 80 of the pressure gauge 10 may be turned off when the portable pressurized fire extinguisher 1 is to be moved to a new location or for maintenance, and thus avoiding sending unintended alarms to the management server.

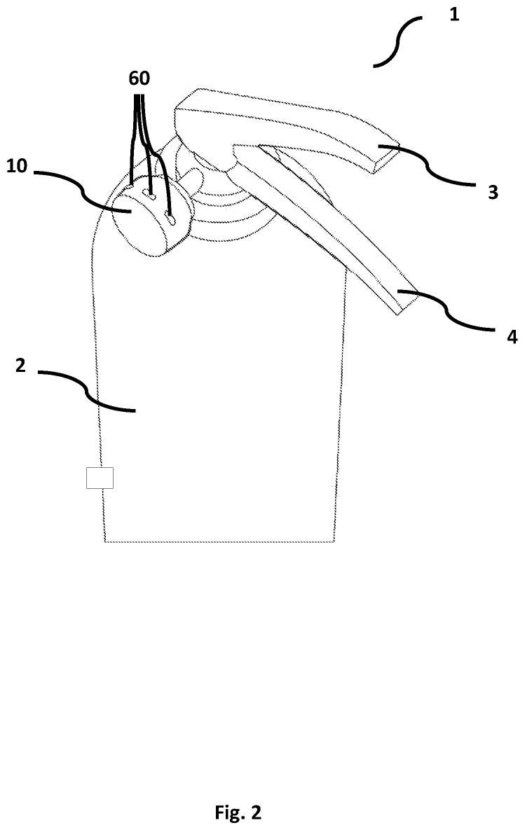

FIG. 2 illustrates a portable pressurized fire extinguisher 1 comprising a tank 2, a lever 3, a handle 4 and a pressure gauge 10 comprising light indicators 60 connected to the portable pressurized fire extinguisher 1. The pressure gauge 10 is suitable for connecting to other types of fire extinguishers 1, for instance having different shapes of tanks 2 or different discharging mechanisms. The light indicators 60 are easily visible and may blink, flash or be on when activated by a user or when a pressure threshold is exceeded. Furthermore, the light indicators 60 may comprise different colors, depending on the current pressure status of the device.

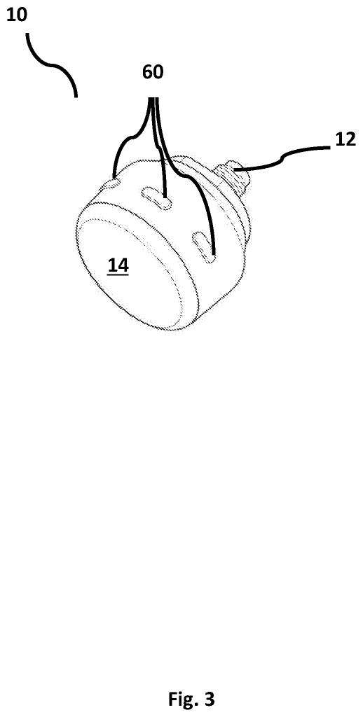

FIG. 3 illustrates a pressure gauge 10 disconnected from the portable pressurized fire extinguisher 1. The pressure gauge 10 comprises a connector 12 that attaches said pressure gauge 10 to the portable pressurized fire extinguisher 1. The connector 12 may be any suitable element for attaching the pressure gauge 10 to the portable pressurized fire extinguisher 1 and that allows obtaining pressure data The connector 12 may comprise a thread for screwing the pressure gauge 10 to the fire extinguisher 1. Said connector 12 is standard in the field and is easily attachable to standard fire extinguishers 1.

The pressure gauge 10 may have any shape, however a ring shape is preferred. Said pressure gauge 10 comprises a surface 14 which is touch sensitive and which is located on the opposite side of the connector 12. A user can touch or tap said surface 14 for obtaining the current status of the fire extinguisher 1. The touching or tapping of the surface 14 of the pressure gauge 10 may activate the light indicator 60, thereby visually showing the current status of the of the fire extinguisher 1. As described elsewhere herein, the light indicator 60 may blink, flash or be constantly on to indicate the current status of the fire extinguisher 1, when a user touches or taps the surface 14 of the pressure gauge 10. The current status is shown for a short period of time for further saving energy, for instance for about from 1 second to 60 seconds.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Unless expressly described to the contrary, each of the preferred features described herein can be used in combination with any and all of the other herein described preferred features.

1. A pressure gauge for a portable pressurized fire extinguisher comprising a pressure sensor, a LoRa radio interface and a power source; wherein
the pressure sensor is configured to sense an inner gas pressure of the portable pressurized fire extinguisher; and
the LoRa radio interface is powered by the power source and configured to transmit pressure data from the pressure sensor to a management server; wherein
the pressure gauge further comprises a near-field communication NFC interface, which is configured to send and receive pressure data to and from the pressure sensor.

2. The pressure gauge according to claim 1, wherein said pressure gauge is configured to have an upper pressure threshold and/or a lower pressure threshold for the inner gas pressure of the portable pressurized fire extinguisher.

3. The pressure gauge according to claim 2, wherein the upper pressure threshold and/or the lower pressure threshold can be updated by an external device through the pressure data communicated by the NFC interface.

4. The pressure gauge according to claim 2, wherein the LoRa radio interface is configured to only transmit pressure data from the pressure sensor to the management server when the upper and/or lower threshold is/are reached.

5. The pressure gauge according to claim 2, wherein said pressure gauge is configured to send an alarm to the management server when the upper pressure threshold and/or the lower pressure threshold is/are exceeded.

6. The pressure gauge according to claim 1, further comprising a temperature sensor, wherein the pressure gauge is configured to have an upper temperature threshold and/or a lower temperature threshold for the surroundings of the portable pressurized fire extinguisher.

7. The pressure gauge according to claim 6, wherein said pressure gauge is configured to send an alarm to the management server when the upper temperature threshold and/or the lower temperature threshold is/are exceeded.

8. The pressure gauge according to claim 1, wherein the power source is an electric battery.

9. The pressure gauge according to claim 1, further comprising a motion sensor, such as an accelerometer, configured to detect a displacement of the portable pressurized fire extinguisher.

10. The pressure gauge according to claim 9, wherein said pressure gauge is configured to send an alarm to the management server when a motion threshold is exceeded.

11. The pressure gauge according to claim 1, further comprising a light indicator, such as a LED light indicator.

12. The pressure gauge according to claim 11, wherein said light indicator is configured to display a status of the portable pressurized fire extinguisher, said status being defined as normal, low pressure or high pressure.

13. The pressure gauge according to claim 11, wherein said light indicator is configured to display a light signal when the upper pressure threshold and/or the lower pressure threshold is/are exceeded.

14. The pressure gauge according to claim 11, wherein said light indicator is activatable by a user, such as by papping or touching said light indicator by a user.

15. A portable pressurized fire extinguisher comprising the pressure gauge according to claim 1.

16. A use of the pressure gauge, according to claim 1, for monitoring a portable pressurized fire extinguisher.

17. A system comprising a plurality of pressure gauges as defined in claim 1 and plurality of portable pressurized fire extinguishers, wherein each one of the plurality of pressure gauges is connected to each one of the plurality of portable pressurized fire extinguisher.
